(19) United States
(12) Patent Application Publication
(10) Pub. No.: US 2025/0217993 A1
(43) Pub. Date: Jul. 3, 2025

(54) METHOD FOR OBSERVING BIOLOGICAL SAMPLE

(71) Applicants: RIGAKU CORPORATION, Tokyo (JP); KANAZAWA MEDICAL UNIVERSITY, Ishikawa (JP)

(72) Inventors: Koichirou ITO, Tokyo (JP); Naoki KUNISHIMA, Tokyo (JP); Kengo FURUICHI, Ishikawa (JP)

(73) Assignees: RIGAKU CORPORATION, Tokyo (JP); KANAZAWA MEDICAL UNIVERSITY, Ishikawa (JP)

(21) Appl. No.: 19/001,863

(22) Filed: Dec. 26, 2024

(30) Foreign Application Priority Data
Dec. 28, 2023 (JP) 2023-223642

(51) Int. Cl. G06T 7/11; G02B 21/36; G06T 7/174; G06T 7/62; G21K 7/00

(52) U.S. Cl. CPC G06T 7/11; G02B 21/367; G06T 7/174; G06T 7/62; G21K 7/00; G06T 2207/10056; G06T 2207/10116; G06T 2207/30024

(57) ABSTRACT

A method for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, the method comprising the steps of: extracting a region of interest, including the evaluation target region, from the image of the X-ray microscope that has been matched with the image of the light microscope; and binarizing the region of interest to further extract the evaluation target region from the region of interest by using the image information of the light microscope and the X-ray microscope in a complementary manner.

### CROSS-REFERENCE TO RELATED APPLICATION

This application claims priority to Japanese Patent Application No. 2023-223642, filed Dec. 28, 2023, which is incorporated herein by reference in its entirety.

### TECHNICAL FIELD

The present invention relates to a method for extracting an evaluation target region of a biological sample in three dimensions from images of a same measurement point of the same biological sample, which are captured by X-ray and light microscopes and precisely matched, to practically evaluate the evaluation target region at cellular-level spatial resolution.

### BACKGROUND ART

Pathological evaluation of biological tissues is mainly based on pathological evaluation in a plane (two-dimensional) section excised from a pathology specimen. However, pathological changes develop spatially (three-dimensionally) within the tissue. In addition, when a pathology specimen is prepared, part of the subject is discarded and cannot be evaluated. Given this situation, development of a method for evaluating a subject in a three-dimensional manner and a method for evaluating a subject as a whole has been an important problem to be solved.

As conventional methods for observing biological samples, the method of imaging a biological sample using microscopy (Patent literature 1), the method of imaging the kidney (tubule) of a rat (Patent literature 2), and the method of infiltrating a biological sample with a contrast agent and solidifying it to increase the contrast (Patent literature 3) are known.

### CITATION LIST

### Patent Literature

[Patent literature 1] Japanese Unexamined Patent Application Publication (Translation of PCT) No. 2020-528557
[Patent literature 2] Japanese Unexamined Patent Application Publication No. 2014-211448
[Patent literature 3] Pamphlet of International Publication WO2022/234844

### SUMMARY OF THE INVENTION

### Problem to be Solved by the Invention

However, there is currently no practical observation method that can evaluate pathological changes in a subject in a three dimensional manner at cellular-level spatial resolution. While a light microscope has the advantages of a relatively high two-dimensional resolution of about 0.2 μm and accurate tissue identification capability by use of a variety of staining methods, it has limitations in microscopic observation due to sample deformation (destructive deformation) caused by physical forces applied during sample preparation and insufficient depth resolution that can be caused by a sample thickness of about 4 μm. On the other hand, while an X-ray microscope has the advantages of isotropic submicron three-dimensional resolution and non-destructiveness which allows samples to be reused, it produces low-contrast gray-scale images because the shading of the X-ray microscope image is determined by the electron density of the relatively light elements that make up the biological sample, rendering tissue identification difficult. Therefore, there was a need to develop a practical method for observing a same measurement point of a same biological sample in three dimensions at cellular-level spatial resolution by combining an X-ray microscope and a light microscope to compensate for the above limitations and difficulties.

The present inventor has diligently studied to solve the above problem, and, as a result, succeeded in extracting an evaluation target region of a biological sample in three dimensions from images of a same measurement point of the same biological sample, which are captured by X-ray and light microscopes and precisely matched, to practically evaluate the evaluation target region at cellular-level spatial resolution, by binarizing the X-ray microscope image and using the image information from the light and X-ray microscopes in a complementary manner, thereby completing the present invention.

### Means to Solve the Problem

Thus, the present invention is as follows.

[1] A method for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, the method comprising the steps of:
extracting a region of interest, including the evaluation target region, from the image of the X-ray microscope that has been matched with the image of the light microscope; and
binarizing the region of interest to further extract the evaluation target region from the region of interest by using the image information of the light microscope and the X-ray microscope in a complementary manner.

[2] A method for evaluating a biological sample, comprising a step of evaluating the volume or shape of the evaluation target region extracted by the method according to [1].

[3] The method according to [2], wherein the volume is evaluated by multiplying the number of voxels in the image of the binarized evaluation target region by the voxel volume.

[4] A method for displaying an evaluation target region of a biological sample, comprising a step of displaying the evaluation target region extracted or evaluated by the method according to any one of [1]-[3] in a three-dimensional manner.

[5] A microscope image processing device for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, the device comprising:
a means for extracting an observation target region (region of interest), including the evaluation target region, from the images of the biological sample, which are captured by the X-ray microscope and the light microscope and matched; and
a means for binarizing the extracted region of interest to further extract the evaluation target region from the region of interest.

[6] The device according to [5], wherein the extraction of the region of interest and the extraction of the evaluation target region are performed by comparing the light microscope image with the X-ray microscope image using image analysis software having a function of creating a binary image and a function of selecting a shape or a region.

[7] The device according to [5], further comprising a means for evaluating the volume or shape of the extracted evaluation target region.

[8] The device according to [7], wherein the volume is evaluated by multiplying the number of voxels in the image of the binarized evaluation target region by the voxel volume.

[9] The device according to any one of [5]-[8], further comprising a means for displaying the extracted or evaluated evaluation target region in a three-dimensional manner.

[10] A program for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, wherein the program enables a computer to function as the following means:
a means for extracting an observation target region (region of interest), including the evaluation target region, from the images of the biological sample, which are captured by the X-ray microscope and the light microscope and matched; and
a means for binarizing the extracted region of interest to further extract the evaluation target region from the region of interest.

[11] A computer-readable recording medium storing the program according to above.

### Effects of the Invention

The present invention has made it possible to practically evaluate an evaluation target region of a biological sample at cellular-level spatial resolution by extracting the evaluation target region in three dimensions from images of a same measurement point of the same biological sample, which are captured by X-ray and light microscopes and precisely matched. The present invention provides a method for practically observing a same measurement point of a same biological sample in three dimensions at cellular-level spatial resolution by the complementary use of an X-ray microscope and a light microscope.

### BRIEF DESCRIPTION OF DRAWINGS

FIG. 1 Figure showing a general sample preparation process for observing a biological sample with X-ray and light microscopes.

FIG. 2 Figure showing an embedding dish for embedding a biological sample in wax.

FIG. 3 Figure showing a process of producing an embedded block by embedding a biological sample in wax.

FIG. 4 Figure showing the placement of the embedded block on an embedding cassette.

FIG. 5 Figure showing shapes of cassettes for wax contrast imaging.

FIG. 6 Figure showing an aspect of mounting a sample for X-ray microscopy.

FIG. 7 Figure showing attachment of the block-mounted cassette to a stage.

FIG. 8 Figure showing the relationship between the biological sample and the X-ray irradiation direction.

FIG. 9 Figure showing a position adjusting mechanism for adjusting the position of the stage.

FIG. 10 Figure showing a process of observation with a light microscope, which is performed after observation with an X-ray microscope.

FIG. 11 Figure showing an overview of acquiring location information from a three-dimensional image.

FIG. 12A Figure showing an overview of an orientation adjustment process in X-ray and light microscope images.

FIG. 12B Figure showing a flowchart of the orientation adjustment process.

FIG. 13 Figure showing an overview of a microscope image processing device.

FIG. 14 Block diagram showing actions of an information processing device.

FIG. 15 Figure showing a flowchart of the orientation adjustment process by the microscope image processing device.

FIG. 16 Figure showing a process of preparing a wax block for observation with a light microscope, from a plate-shaped wax block sample that has already been observed with an X-ray microscope without being attached to an embedding cassette.

FIG. 17 Figure showing an aspect in which a step of observing a biological sample with an X-ray microscope is integrated into a step of observing the biological sample with a light microscope.

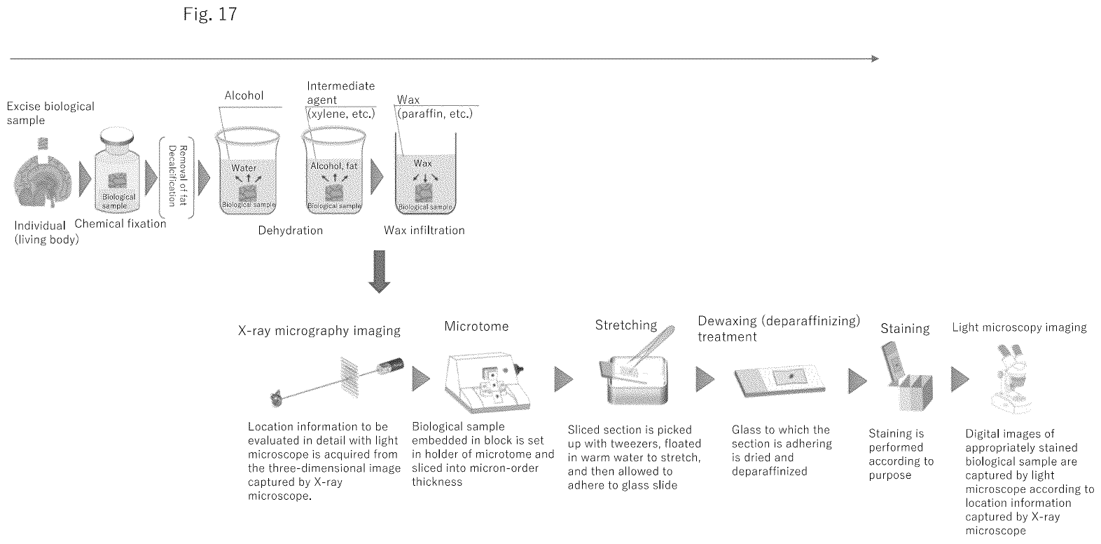

FIG. 18 Figure showing an overview of acquiring location information from an actual three-dimensional X-ray microscope image using a biological sample. A: CT slices that have been edited to give the same views as observed with the light microscope. The locations of the renal corpuscle are indicated by arrows. B: Partial magnification of the renal corpuscle. The internal structure necessary to confirm a lesion in the kidney can be confirmed. C: Partially magnified CT slice of the renal corpuscle obtained by reducing the image data to an angle range of 150°. Essentially the same results were obtained as with the total data.

FIG. 19 Figure showing a process of designating, among the observation target regions including the characteristic cell nuclei present in the light microscope image (top panel), about 10 marker regions, i.e., regions including the cell nuclei, that are not present in the fiducial slice of the X-ray microscope (bottom panel) but are present within about 20 slices above or below that fiducial slice. The location of each region is indicated by a circle and labeled F for the fiducial region and M1-10 for the marker regions. As an example, marker slice 1, where marker region 1 is present, is shown in the middle panel. In the fiducial slice, locations of the projected marker regions, which are the z-projections of the marker regions, are shown.

FIG. 20 Figure showing a flowchart of processes from extraction of a region of interest to evaluation of the three-dimensional shapes of an evaluation target region.

FIG. 21 Figure showing a process of extracting a region of interest from an X-ray microscope image by image processing.

FIG. 22 Figure showing a process of extracting a lesion (evaluation target region) from the X-ray microscope image by image processing.

FIG. 23 Figure showing a volume rendering of X-ray microscope image (middle panel) corresponding to a light microscope image of the renal corpuscle (left panel) and a volume rendering of X-ray microscope image near the lesion (right panel). The lesion is enclosed by a dashed line. In the three-dimensional view in the middle panel, the outermost dark brown area of the renal corpuscle is the parietal layer of the Bowman's capsule, the innermost round area is the glomerulus, and the space between the two is the Bowman's space. The translucent portion of the glomerulus is low-density tissue and the opaque portion is high-density tissue, and the two are distinguished by binarization. The high-density tissue is an area where cells are clustered and appears continuously in the depth direction in the three-dimensional view. An area of the high-density tissue extracted as a lesion is shown in white. In the right panel, the lesion (white area) is composed of multiple lesion protrusions arising from a single normal mesangial cell chain (light brown area), which have fused and grown into a large multi-protrusion fusion type lesion.

### DESCRIPTION OF EMBODIMENTS

The present invention relates to a method for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging. The method of the present invention comprises the steps of:

extracting a region of interest, including the evaluation target region, from the image of the X-ray microscope that has been matched with the image of the light microscope; and binarizing the region of interest to further extract the evaluation target region from the region of interest by using the image information of the light microscope and the X-ray microscope in a complementary manner.

Hereinafter, an aspect of extracting a region of interest, including an evaluation target region, from two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, and binarizing the region of interest to further extract the evaluation target region from the region of interest by using the image information of the light microscope and the X-ray microscope in a complementary manner, will be described.

### 1. Preparation of Block of Biological Sample for X-Ray Imaging

### (1) Preparation of Biological Sample

In order to observe the three-dimensional structure of a biological sample at submicron resolution with an X-ray microscope, the present invention uses the wax contrast imaging described in WO2022/234844 with some modifications. The “wax contrast imaging” described in the above publication is a method in which the contrast for X-rays is enhanced using the negative contrast effect by infiltrating a biological sample with wax, such as paraffin, to replace water in the sample, then making a block by embedding the wax-infiltrated biological sample in the same wax, and irradiating the block with X-rays to capture an X-ray microscope image of the embedded biological sample.

Since unstained biological samples generally have low contrast for X-rays, it is difficult to observe them in their current form at cellular-level spatial resolution using an X-ray microscope. The reason for this is that water, which is the major component in the unstained biological sample, and other components have similar X-ray transmittance. In the wax contrast imaging, water in the biological sample is replaced by wax with higher X-ray transmittance to improve the contrast and enable observation with an X-ray microscope at the cellular level. Wax contrast imaging is a type of technique commonly referred to as negative contrast in CT.

The present invention uses a plate-shaped wax block with a very large maximum X-ray path length and does not remove the excess wax around the biological sample to be examined and thus differs in this respect from the wax contrast imaging described in WO2022/234844.

Specifically, in the method described in WO2022/234844, it was necessary to remove as much of the wax around the tissue to be observed from the X-ray microscopic observation sample as possible in order to obtain better spatial resolution and to set the maximum X-ray path length to 2 mm or less. In contrast, in the present invention, the biological sample to be observed is embedded in a wax block, and the maximum X-ray path length exceeds 2 mm. If the maximum path length exceeds 2 mm, the spatial resolution will be slightly inferior, but the submicron spatial resolution can be maintained by setting the minimum X-ray path length to 2 mm or less.

Therefore, observation with an X-ray microscope using the block of the present invention can greatly improve the adaptability to a conventional biological sample observation process using a light microscope, while maintaining the spatial resolution required for complementary observation with the light microscope. Thus, the wax block of the present invention has a biological sample embedded therein and has a minimum X-ray path length of 2 mm or less and a maximum X-ray path length of greater than 2 mm. Although there is no theoretical limit on the maximum X-ray path length of the block, for example, it can be set to 35 mm or less in consideration of the size of a common embedding dish to further enhance the adaptability to the biological sample observation process using a light microscope.

A biological sample for use in the present invention can by prepared by following the general process of preparing a sample for observation with a light microscope.

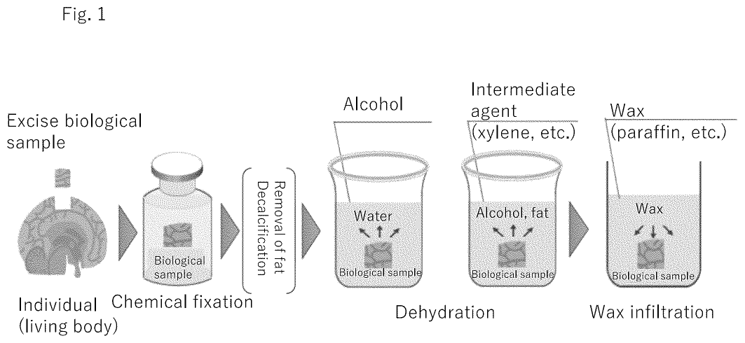

FIG. 1 shows a process diagram starting from excision of a biological sample to wax infiltration by placing the biological sample in wax such as paraffin.

In FIG. 1, chemical fixation is performed on a sample (biological sample) collected by excising cells or tissue from a living body, for example, using formalin, glutaraldehyde, alcohol, Bouin's solution, etc. Subsequently, dehydration is carried out using alcohol, xylene, etc., followed by wax infiltration. Removal of fat and decalcification are optional, and either or both can be performed as needed. Wax refers to a lipophilic compound that is solid at room temperature (20° C.-30° C.) and has a melting point of 40° C.-80° C. Examples of wax include paraffin, other petroleum waxes, and synthetic waxes, but paraffin is preferred.

(2) Embedding Dish for Wax Contrast Imaging in which Biological Sample to be Examined is Embedded

After the infiltration with wax, such as paraffin, the biological sample to be examined is embedded.

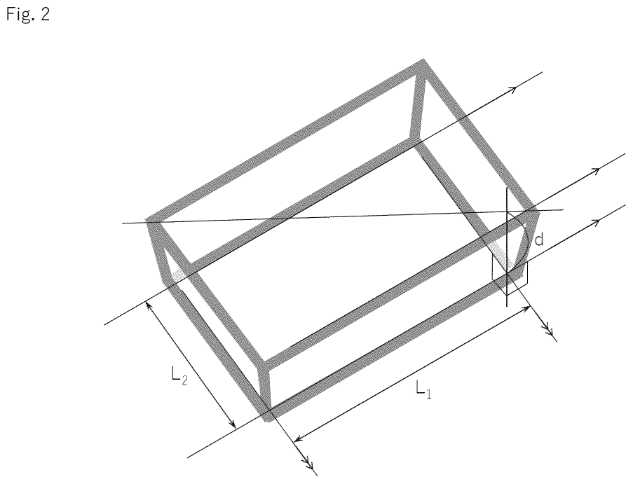

A schematic diagram of an embedding dish for embedding the biological sample to be examined is shown in FIG. 2.

FIG. 2 shows, as an example, an embedding dish with a rectangular opening and bottom, with a length L1 of 3-32 mm in the lengthwise (longitudinal) direction and a length L2 of 3-28 mm in the transverse direction on the bottom surface of the inner walls, and a depth d of 2 mm or less.

Note that in the present invention, the shape of the opening (top) and bottom of the embedding dish is not limited and may be square, circular or oval, as well as rectangular. Furthermore, the side walls of the embedding dish may have a shape extending normal to the bottom, i.e., a rectangular parallelepiped shape in which the area of the bottom inner wall is equal to that of the top inner wall, or a shape in which the area of the top inner wall is larger than that of the bottom inner wall, i.e., the bottom inner wall is tapered from the top (shape in which the extended lines of the side walls are tapered towards the bottom).

The depth d of the embedding dish is 2 mm or less, but it is preferably 1.0-1.5 mm, e.g., 1.2 mm. The depth of this embedding dish is the thickness of the block in which the biological sample is embedded.

The area of the bottom surface of the inner walls of the embedding dish in which the biological specimen is to be embedded, i.e., the area of the block surface that is molded by the bottom surface of the inner walls of the embedding dish and that is thus defined as the upper surface of the block, is 9-900 mm². However, these areas are not limited to this, and a person skilled in the art can appropriately determine the size of the block for X-ray microscopy imaging.

The material of the embedding dish may be stainless steel or other metal, glass or ceramic, hard or soft resin, paper, or wood, but is not limited to these and may be other material.

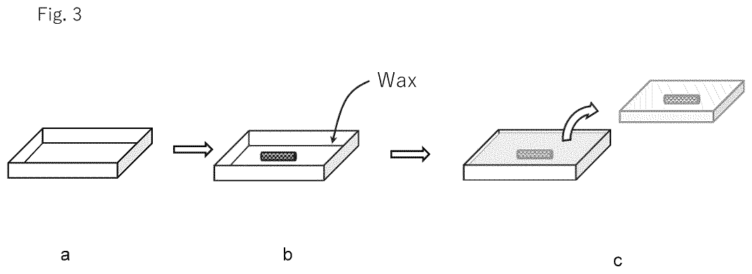

As shown in FIG. 3, a plate-shaped wax block with a thickness of 2 mm or less, embedded with a biological sample, is prepared by placing the biological sample in an embedding dish with a depth of 2 mm or less and pouring wax into the embedding dish.

For example, the biological sample is placed in the approximate center of the embedding dish (FIGS. 3a and b), into which wax is poured and allowed to solidify. By taking out the solidified wax, a block embedded with the biological sample (hereafter also simply referred to as a “block”) can be prepared (FIG. 3c).

The order of placing the biological sample and pouring the wax into the embedding dish is not limited to the above and is arbitrary. Specifically, the biological sample can be placed in the wax in advance so that the biological sample is poured into the embedding dish together with the wax. Alternatively, the embedding dish can be prefilled with the wax and the biological sample can then be placed in the dish. It is preferable to finely adjust the biological sample in the embedding dish so that it is positioned in the center of the block before the wax solidifies. In the present invention, the biological sample may be allowed to float in the wax, but is preferably placed in contact with the bottom of the embedding dish.

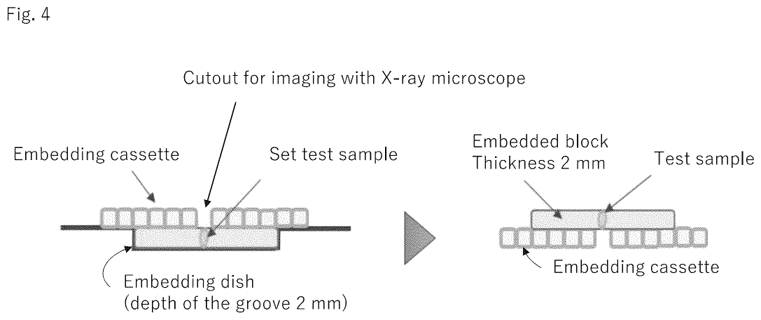

Before the wax solidifies, a cassette for X-ray imaging (referred to as an “embedding cassette”) is further placed on the embedding dish in which the biological sample has been embedded, and by allowing the wax to solidify while the surface of the wax poured into the embedding dish is in contact with the embedding cassette, a combined unit of the embedding cassette and the embedded block can be made by subsequently taking out the block from the embedding dish (FIG. 4).

2. Embedding Cassette for Wax Contrast Imaging on which Biological Sample to be Examined is Mounted

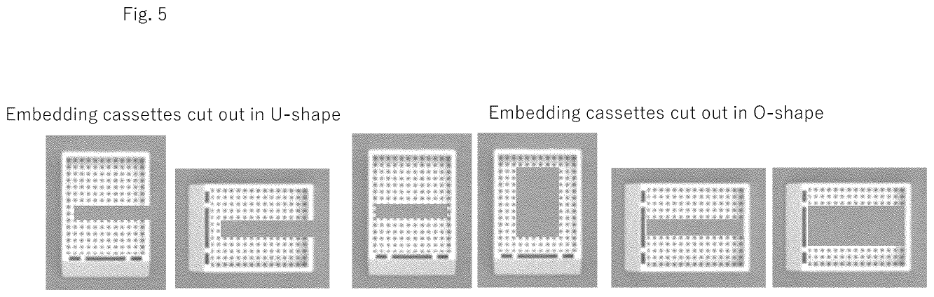

In the present invention, the embedding cassette for mounting the block embedded with the biological sample to be examined has a strip-like or rectangular-shaped cutout (space) to allow X-rays to pass through when irradiated with X-rays, as shown in FIG. 5. The block is mounted on the cassette so that the area to be irradiated with X-rays, i.e., the embedded biological sample, is positioned within the cutout area. The size of the cutout in the cassette should be larger than the area of the imaging site of the biological sample to be examined. In other words, the size of the imaging site of the biological sample is adjusted to fit within the area of the cutout in the cassette. The above cutout is designed so that when X-ray imaging is performed using the cassette, the lost rotation angle range caused by the cassette blocking X-rays is less than 30°, in other words, X-rays are not blocked even when the imaging rotation angle range is 150° or more. Details of the imaging rotation angle range will be described later. The biological sample is placed in the embedded block in the embedding dish so as to satisfy an imageable angle range of 150° or more in the X-ray microscope, but not only the blocking of X-rays by the cassette, but also other factors, such as the blocking of X-rays by the thickness of the wax embedded with the biological sample itself, may be considered.

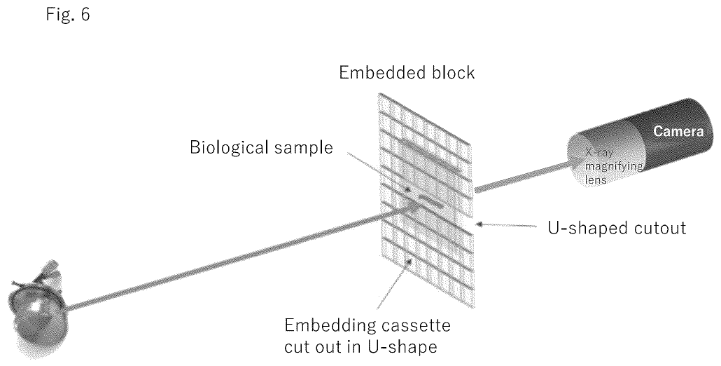

FIG. 6 is a figure showing that the embedded block is mounted such that the biological sample is positioned in the cutout area of the cassette, and is arranged in the direction of radiation of X-rays in the X-ray microscope. As shown in FIG. 6, X-rays are emitted from an X-ray generator of the X-ray microscope toward the block, and the X-rays pass through the cutout in the cassette (in FIG. 6, the strip-like cutout) to irradiate the biological sample in the block mounted on the cassette.

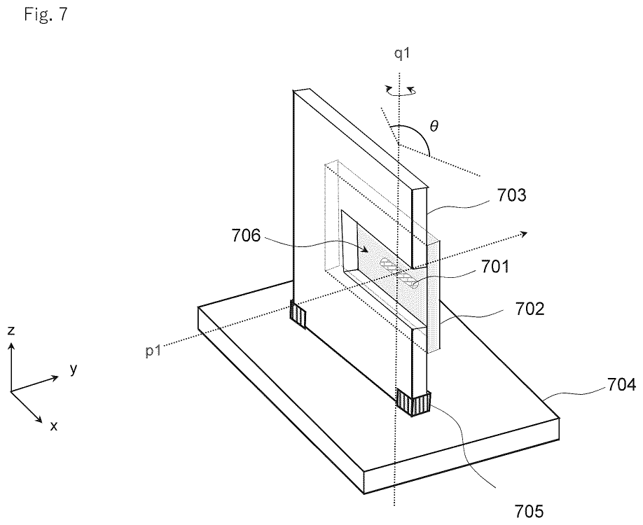

FIG. 7 is a figure showing the attachment of the block-mounted cassette to a stage.

In FIG. 7, a block 702 embedded with a biological sample 701 is provided on a cassette 703 and positioned such that the biological sample 701 fits within a cutout area 706 of the cassette.

Specifically, the biological sample is placed within the cutout to satisfy an imageable angle range of 150° or more, as will be described below. The cassette is then attached onto a stage so that the block is positioned on the detector side (the side opposite the side where the X-rays enter).

In FIG. 7, the longitudinal direction of the biological sample is oriented in the x-direction (horizontal), but it can also be oriented in the z-direction (vertical). In this case, the cassette may be positioned so that the cutout in the cassette faces the top, or the biological sample may be placed such that its longitudinal direction is oriented vertically (z-direction) as long as the biological sample 701 fits within the horizontal cutout area.

The cassette 703 is attached onto the stage 704 via attachment members 705. The attachment members 705 are capable of attachment by providing the stage with recessed fitting jigs and fitting the ends of the cassette into the fitting jigs as shown in FIG. 7. In the aspect shown in FIG. 7, two ends of the cassette 703 are fitted into the attachment members 705. However, there is no particular limitation on the members used to attach the cassette to the stage, and the cassette may be attached using double-sided tape or clay (not shown), or using clips or screw fasteners. When clips are used, the cassette is attached by utilizing the elasticity of an object such as a plate spring. When screw fasteners are used, the cassette is attached by utilizing a set screw or the like.

After attaching the cassette 703 onto the stage 704, it can be moved left and right or back and forth (x or y direction) or up and down (z direction) by a position adjusting mechanism (details will be described later) of the stage 704 so that substantially the center of the biological sample is positioned on the X-ray radiation path (optical path) p1. The X-ray radiation path p1 is perpendicular to the block 702, but if a rotation axis q1 is provided perpendicular to the xy-plane and at the approximate center of the biological sample 701, and the block 702 is rotated about the rotation axis q1, p1 is oblique to the block 702. In other words, the X-ray path is oblique to the block 702. This rotation angle θ is the rotation angle range for X-ray imaging, and rotation of up to 150° or more, preferably 180° or more, is possible.

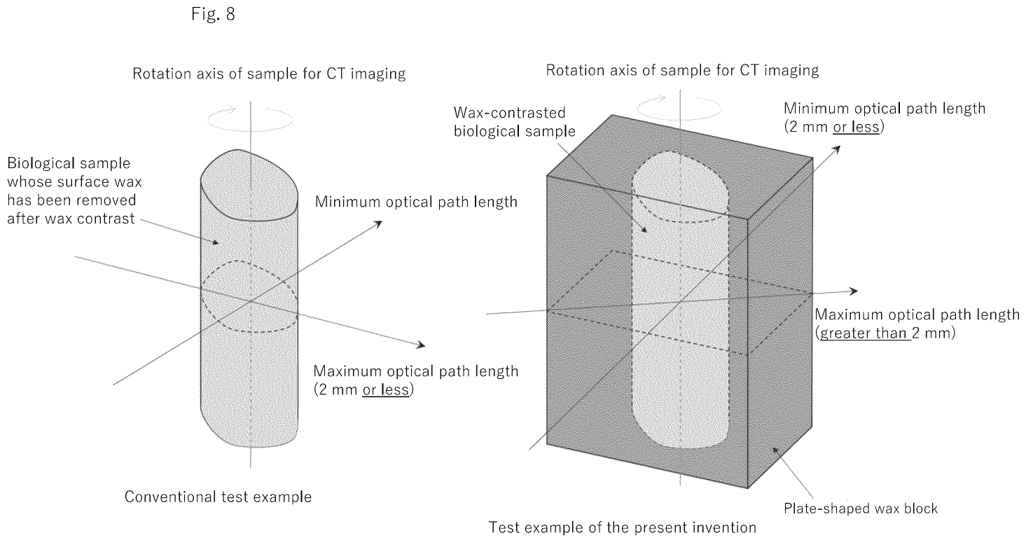

The relationship between the biological sample 701 and the direction of the X-ray radiation is shown in FIG. 8.

In FIG. 8, the left panel shows the minimum and maximum optical path lengths for X-ray imaging in a conventional test example. Conventionally, X-ray imaging is performed on a biological sample whose surface wax has been removed after wax contrast imaging, so that the maximum and minimum optical path lengths are nearly equal to the thickness or length of the biological sample.

On the other hand, in the present invention, X-ray irradiation is performed on a plate-shaped wax block embedded with a wax-contrasted biological sample, so the optical path length depends on the length or thickness of the block. Even if the thickness of the block is 2 mm or less, the optical path can be extended to a length close to the longitudinal direction of the block by rotating the block by a certain angle θ about the rotation axis of the sample (test example of the present invention; FIG. 8, right panel). In the present invention, the minimum value of the X-ray path length of the block is 2 mm or less and the maximum value is greater than 2 mm. Although there is no theoretical limit on the maximum X-ray path length of the block, it is preferably 35 mm or less in consideration of the size of a common embedding dish. The sample can be rotated by fixing the sample and rotating the X-ray source and the camera relative to the sample, or by fixing the X-ray source and the camera and rotating the sample. The rotation axis (direction) may be in the longitudinal or transverse direction of the sample.

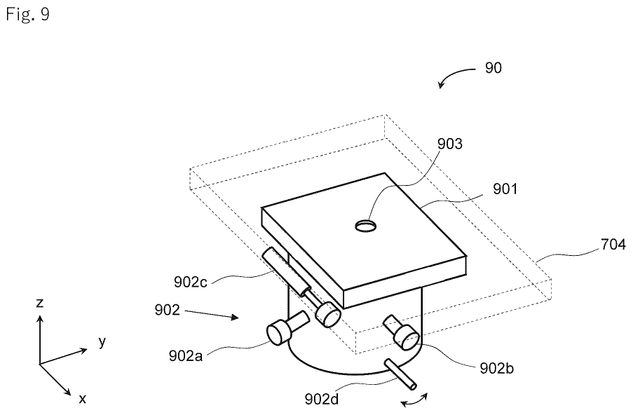

FIG. 9 shows a position adjusting mechanism 90 for adjusting the xy-direction (horizontal direction), z-direction (vertical direction), and 0 (rotation angle) of the stage 704.

The position adjusting mechanism 90 is a mechanism for aligning the position of the observation target for light microscopic observation, and is provided with a support table 901 on which the stage 704 is placed, and an adjusting unit 902 for adjusting the xy-direction (horizontal direction), z-direction (vertical direction), and the horizontal rotation angle of the support table 901. A projection (not shown) may be provided on the bottom of the stage 704, and a securing hole 903 or the like may be provided in the support table 901 to fit and fix the projection therein. The adjusting unit 902 is provided with an adjustment knob 902a for adjusting the x-direction of the stage 901, an adjustment knob 902b for adjusting the y-direction, an adjustment knob 902c for adjusting the z-direction, and a knob 902d for adjusting the horizontal rotation angle of the support table 901. When referring to x-direction, y-direction, z-direction, and rotation angle, it goes without saying that the adjustment can also be made in the negative direction (e.g., if x-direction is positive to the right, then to the left, and so on). The position adjusting mechanism 90 may be a manual mechanism or an electrical mechanism that can be automatically controlled by a computer program or the like.

### 3. X-Ray Imaging

For wax contrast imaging, X-rays having an energy of 4-12 keV are used (e.g., X-ray microscope nano3DX from Rigaku Corporation is used with X-rays of Cu wavelength), and the sample size needs to be adjusted so that the X-rays sufficiently transmit through the sample. Accordingly, in the present invention, a plate-shaped wax block having a thickness of 2 mm or less, which is embedded with the biological sample to be examined, is mounted such that the surface of the block is aligned with the rotation axis of the X-ray microscope before X-ray imaging is performed. As mentioned above, the block is mounted on the cassette of the present invention, and the cassette is further attached to the stage with an attachment member or a removable adhesive material (double-sided tape, clay, etc.) for X-ray imaging, but in order to increase the accuracy and reproducibility of the setup, a jig with an adjusting mechanism designed to allow the cassette to be attached to the observation stage at a constant sample height and tilt angle can be used.

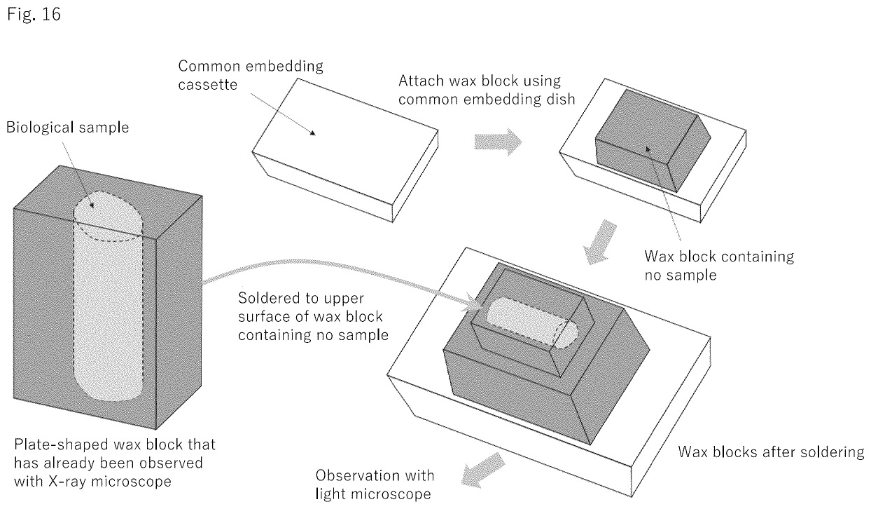

In the present invention, observation with the X-ray microscope may be performed on the plate-shaped wax block alone which is not attached to an embedding cassette. In this case, the plate-shaped wax block that has already been observed under the X-ray microscope is soldered to the upper surface of a wax block containing no biological sample, which is attached to a common embedding cassette without cutouts (FIG. 16). A combined unit of the wax block containing no biological sample mounted on the cassette without a cutout is referred to as a bimembral unit. In the bimembral unit, the wax composing the wax block containing no biological sample is preferably the same as the wax composing the aforementioned plate-shaped wax block, but may be a similar but different type of wax. The term “soldering” refers to the bonding of the plate-shaped wax block and the wax block containing no biological sample by using a molten wax, called a soldering wax, as an adhesive, and then allowing the soldering wax to stand at room temperature to solidify, thereby attaching the two blocks. By soldering the biological sample-embedded wax block that has already been observed under the X-ray microscope to the upper surface of the wax block of the bimembral unit, a combined unit of the bimembral unit and the biological sample-embedded wax block is obtained. This combined unit is referred to as a trimembral unit. The wax of the soldering wax used for making the trimembral unit is preferably the same as the wax composing the aforementioned plate-shaped wax block or wax block containing no biological sample, but it may be a similar but different type of wax. After soldering, the wax blocks can be handled in the same manner as the biological sample that has been embedded in wax and attached to a common embedding cassette. Since the aforementioned plate-shaped wax block included in the soldered wax blocks remains solid throughout the soldering process and maintains the orientation relationship before and after the soldering, the positional information of the plate-shaped wax block is substantially preserved, and deformation of the embedded biological sample can be minimized. Thereafter, observation with a light microscope is carried out according to the process described below.

4. Acquisition of Location Information and Observation with Light Microscope

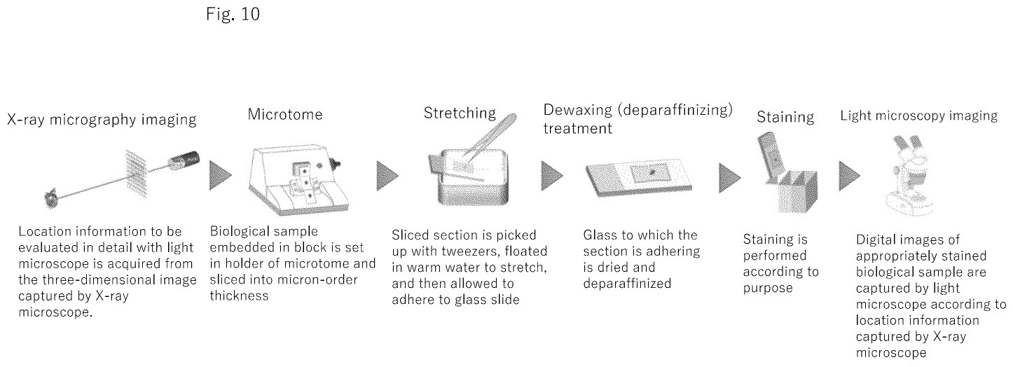

FIG. 10 is a figure showing a process that follows the completion of the X-ray microscopy imaging and that is carried out before the light microscopy imaging.

After imaging with the X-ray microscope, location information to be evaluated in detail with the light microscope is obtained from the three-dimensional image captured by the X-ray microscope.

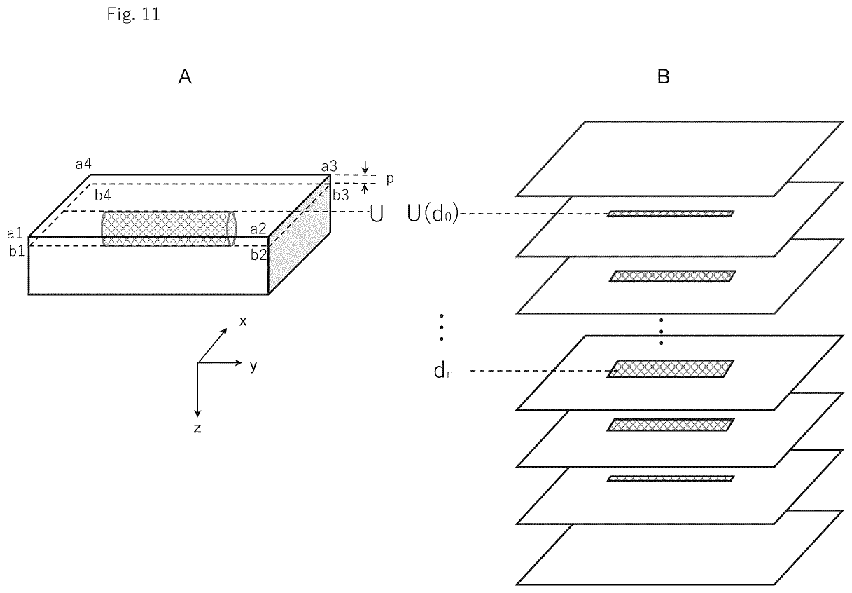

FIG. 11 is a figure showing an overview of acquiring location information from the three-dimensional image.

In FIG. 11, panel A shows a biological sample that has been embedded in a wax block. The three-dimensional image after the X-ray imaging is displayed in the form of CT slices, which are two-dimensional images of cross-sections of the wax block containing the biological sample, cut in arbitrary planes, and stacked sequentially in the direction perpendicular to the slice planes. Among them, any location of the biological sample can be used as a datum plane. For example, the plane tangent to the top edge of the biological sample can be used as the datum plane. In this case, for example, a plane U containing the top edge of the biological sample and parallel to the plane formed by a1-a2-a3-a4 in FIG. 11A (the upper surface of the block), i.e., a plane formed by b1-b2-b3-b4 that is parallel to and is separated by distance p from the plane formed by a1-a2-a3-a4 as seen from the upper surface side and is tangent to the top edge of the biological sample, is used as the datum plane and the block is sequentially sliced into planes parallel to the datum plane (in the xy-direction in the figure), thereby obtaining a series of CT slice images from the top to the bottom of the biological sample (panel B). The thickness of a single CT slice can be set as desired, which determines the number of CT slice images that can be obtained from a biological sample of a given size. Then, regions to be observed (observation target regions) are searched for in the above series of CT slice images. For example, in panel B of FIG. 11, the thickness of a single slice can be set as desired, and thus the distance dₙ from the location (do) of the datum plane U (datum slice) of the biological sample to the n-th image can be obtained. Therefore, for observation with a light microscope, the block is cut with a microtome until the datum plane of the biological sample appears, and then sliced into a micron-order thickness to obtain slices from there to dₙ. Thereafter, stretching, dewaxing, and staining are performed according to the procedure shown in FIG. 10, and light microscopy imaging is performed. In FIG. 11, the plane containing the top edge of the biological sample and parallel to the plane containing the upper surface of the block as seen from the upper surface side is used as the datum plane. However, the datum plane is not limited to this, and any plane, such as a plane containing the bottom edge of the biological sample or the upper or lower surface of the block, may be used as the datum plane. The datum plane may be a plane parallel or not parallel to the plane containing the surface of the block.

The stretching process involves picking up the sliced section with tweezers, allowing it to float in warm water to stretch, and then scooping it up onto a glass slide to adhere.

In the dewaxing process, the glass to which the section is adhering is dried, and then immersed in xylene or the like for a dewaxing treatment.

The staining process uses a method according to the purpose of observation, such as HE (hematoxylin-eosin) staining, which stains cell nuclei separately from other tissues, or PAS reagent (periodic acid Schiff's reagent) staining, which clearly stains the basement membrane.

In the light microscopy imaging process, the appropriately stained biological sample is imaged using a light microscope according to the location information captured by the X-ray microscope to acquire a digital image.

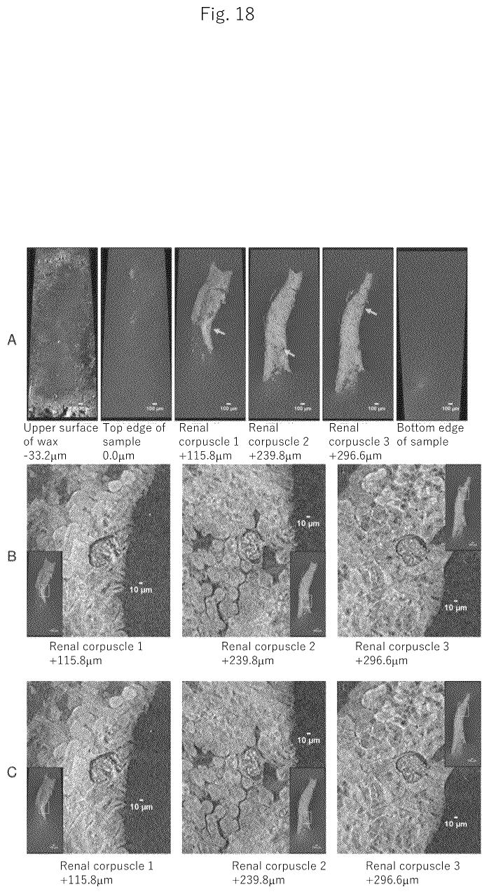

For example, as to the acquirement of location information, the X-ray microscope image can be resliced in the direction perpendicular to the surface of the wax block as shown in FIG. 18A (changing the slice direction of the CT images; e.g., using ImageJ's reslice tool) to specify the exact depth of any object in the sample by using the location of the top edge of the sample as a reference (0.0 μm). In the example shown in FIGS. 18B and C, renal corpuscle 1 is located 115.8 μm from the top edge of the sample. For light microscopic observation, the sample is sectioned as it is after the X-ray imaging with a microtome using a common method without re-embedding it in wax for the light microscopic observation, stained using a common method, and observed using a common light microscope.

As a result, X-ray and light microscope images of the same measurement point of the same biological sample can be easily obtained in a nearly orientation-matched manner. The orientation error between the two images in this state is, for example, 10° or less, but is not limited thereto and can be 10° or more depending on the required precision.

If the sample is sectioned with a microtome at a constant thickness, it is possible to calculate which section contains the object of interest by recording the section where the top edge of the sample appears. In the example shown in FIGS. 18B and C, if the section thickness is 4 μm, the light microscope image corresponding to the X-ray microscope image of renal corpuscle 1 is obtained in approximately the 30th section from the top edge of the sample.

### 5. Collation Between X-Ray Microscope Image and Light Microscope Image

Once an X-ray microscope image and a light microscope image with nearly matching orientations are obtained as initial input images, they can be collated and precisely matched by adjusting the orientation of the X-ray microscope image in the following manner.

### (1) Selection of Arbitrary Observation Target Regions in Biological Sample as Location Markers

First, from the images of the biological sample captured by the X-ray microscope and the light microscope, arbitrary observation target regions, which are contained in the biological sample and can be used as location markers for the orientation adjustment, are selected. The term “image” means both the data of the image itself (data displayed in pixels, etc.) and numerical data such as coordinates. The morphology of the arbitrary observation target regions is not limited, but for example, the size, structure and type of cell or tissue, cell nuclei, and defect morphology can be selected as the location markers.

The defect morphology can be any one of cancer, fibrosis, calcification, lithiasis, and other deposits, or a combination thereof. For example, cell nuclei are used as location markers, with 1 fiducial region selected as a reference for orientation adjustment and about 10 marker regions selected to evaluate the degree of match. The location makers can be selected manually or automatically using AI or the like.

### (2) Process of Collating and Precisely Matching X-Ray Microscope Image and Light Microscope Image

This process is performed by rotating the image (using ImageJ's rotation tool, etc.) with respect to a CT rotation angle and/or a tilt angle in the X-ray microscope, according to the flowchart of the orientation adjustment (details will be described below).

### (3) Flowchart of Orientation Adjustment

The process of collating and precisely matching the X-ray and light microscope images will be described in more detail below.

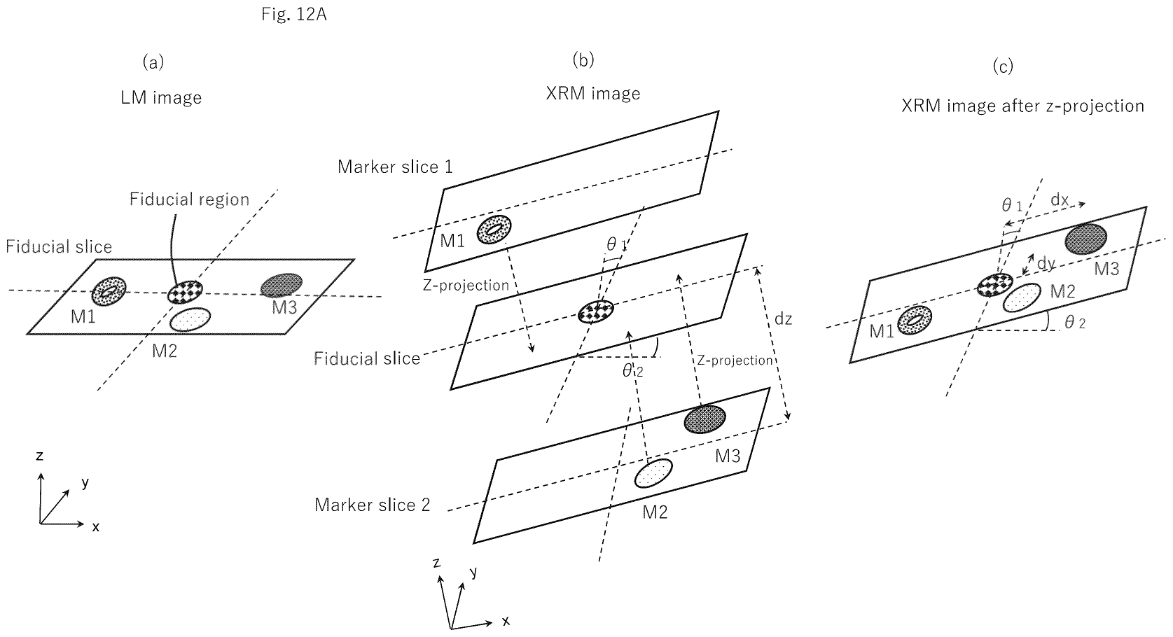

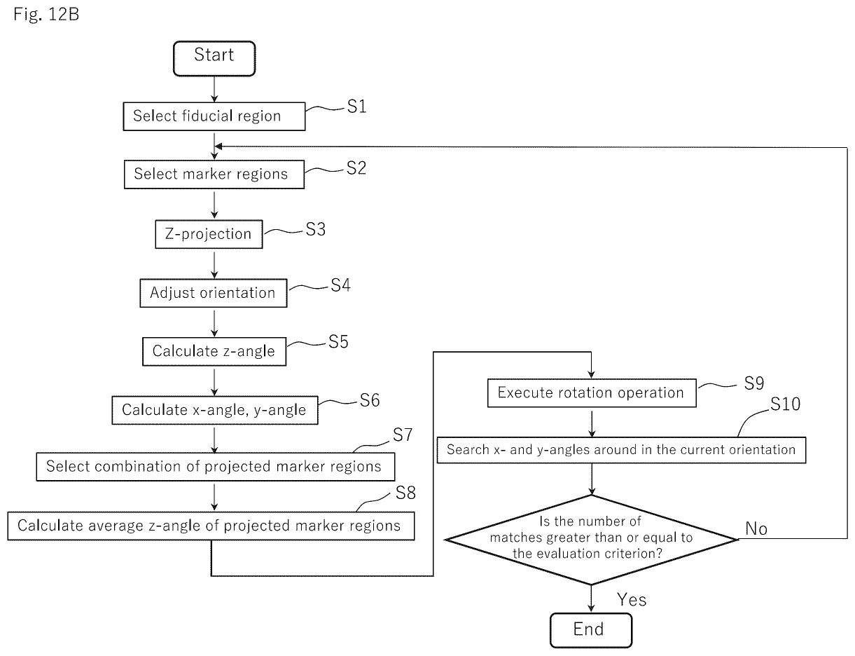

A case of precisely matching a light microscope (LM) image and an X-ray microscope (XRM) image is considered. In FIG. 12A, (a) is an oblique schematic view of a LM image and (b) is an oblique schematic view of XRM images. A flowchart of orientation adjustment is shown in FIG. 12B.

(3-1)

First, one observation target region that contains a location marker (e.g., cell nucleus) that is common in both LM and XRM images is searched, and this region is designated as the fiducial region (step S1). The slice in which the fiducial region exists is called the “fiducial slice”. The fiducial region may contain multiple location markers.

(3-2)

Next, among the observation target regions including the location markers (e.g., cell nuclei) present in the LM image, a number of regions that are not present in the fiducial slice of the XRM image but are present within about 20 slices above or below the fiducial slice are selected (step S2). These regions are called “marker regions” and the slices in which the marker regions are present are called “marker slices”. The number of the selected marker regions is not limited, but 8-20, preferably about 10, marker regions are selected. One marker region may contain multiple location markers.

In FIG. 12A, (b) shows an aspect in which the XRM image is shifted from the x- or y-coordinate of the fiducial slice plane by an angle of θ₁ around the fiducial region in the fiducial slice in a counterclockwise direction and by an angle of θ₂ around the y-axis passing through the center of the fiducial region. Here, θ₁ is referred to as the CT rotation angle and θ₂ as the tilt angle. The CT rotation angle can be clockwise or counterclockwise with respect to the rotation axis. The axis of rotation of the tilt angle can be the x-axis or the y-axis.

When the angles of θ₁ and θ₂ are shifted, location markers in the regions other than the fiducial region in the LM image will not be visible in the XRM image, but they will be present in some slices above or below (e.g., within 10 or 20 slices above or below) the fiducial slice.

FIG. 12A shows an aspect in which three regions (M1, M2 and M3) present in the LM image are selected as marker regions containing location markers (such as cell nuclei) in the XRM image. For the sake of simplicity of explanation, the number of marker regions has been set to three. In FIG. 12A (b), marker slice 1 is a slice in which marker region M1 is present, and marker slice 2 is a slice in which marker regions M2 and M3 are present.

Next, these marker regions are z-projected onto the fiducial slice so that marker region M1 in marker slice 1 and marker regions M2 and M3 in marker slice 2 are projected onto the fiducial slice (FIG. 12A (c), step S3). When selecting the marker regions, it is preferable that when the marker regions are z-projected onto the fiducial slice, the projected marker regions are spread as evenly as possible over the entire fiducial slice.

(3-3)

The projected marker regions are virtual entities. Since the actual XRM image is shifted by θ₁ and θ₂ from the fiducial slice of the LM image, the location markers are not actually present in the projected marker regions in the fiducial slice. Therefore, the orientation is adjusted using, for example, ImageJ's rotation tool, etc., so that the location markers appear in the projected marker regions in the fiducial slice (step S4). Step S4 includes steps S5 through S10. The orientation adjustment is performed in the following manner.

First, a rotation angle is calculated at which the location marker appears in the projected marker region in the fiducial slice. If a marker region is added, calculation is additionally performed only for this region. For a given marker region, let dx (=x_marker−x_fiducial) and dy(=y_marker−y_fiducial) be the distances (pixel units) between the fiducial region and the projected marker region in the x and y directions, respectively, and dz (=z_marker−z_fiducial) the distance between the fiducial slice and the marker slice.

### I)

From the x- and y-axes, select the axis that is more parallel to the line connecting the projected marker region and the fiducial region (selected in the same order), and calculate the z-angle that makes the axis and the line become parallel (step S5).
z-angle=−tan⁻¹(dy/dx), or
z-angle=tan⁻¹(dx/dy)

For example, in FIG. 12A (c), the x-axis is selected because it is more parallel to the line connecting M1 and the fiducial region, and therefore the z-angle is calculated by the former of the two equations above.

### II)

Next, the y-angle or x-angle is calculated at which the location marker appears in the projected marker region in the fiducial slice (formula below) (step S6). For example, the angle θ2 (tilt angle around the x-axis or y-axis) is adjusted so that the cell nucleus, etc., selected as the location marker contained in the marker region appears on the fiducial slice. Specifically:
y-angle={if dx>0, tan⁻¹(dz/sqrt (dx²+dy²)) else-tan⁻¹(dz/sqrt (dx²+dy²))}, or
x-angle={if dy>0,−tan⁻¹(dz/sqrt (dx²+dy²)) else tan⁻¹(dz/sqrt (dx²+dy²))}

For example, since the x-axis is selected for M1 in FIG. 12A (c), y-angle is calculated by the former of the two equations above. The sign is determined by the value of dx.

(3-4)

Furthermore, among combinations of two projected marker regions, a pair is selected that makes an angle closer to the right angle via the fiducial region (step S7).

For example, in FIG. 12A (c), a pair that makes an angle closer to the right angle is selected from (i) the angle made by M1-fiducial region-M2, (ii) the angle made by M2-fiducial region-M3, and (iii) the angle made by M1-fiducial region-M3. If the angle (i) is 89°, the angle (ii) is 80°, and the angle (iii) is 180°, the pair that is closer to the right angle is the pair of M1 and M2 in (i).

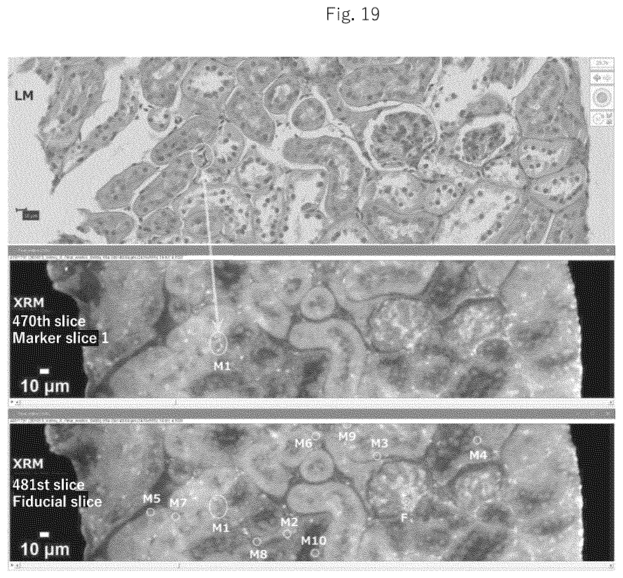

As a specific example, in FIG. 19, the pair of M4 and M9 is selected because the angle M4-F-M9 made by this pair is 87.1°, which is close to the right angle.

The average z-angle of the selected pair of projected marker regions is calculated (formula below) (step S8). Specifically:
z-angle=(z-angle_1+z-angle_2)/2

As a specific example, in FIG. 19, the z-angles of M4 and M9 are 40.6° and 37.6°, respectively, so the average z-angle is 39.1°. Conversely, it is possible to find a pair of marker regions that have a more orthogonal relationship by selecting a pair of marker regions with close z-angles. If a marker region is added, a pair of marker regions that have a more orthogonal relationship can be reselected based on the z-angles to improve the match.

(3-5)

The values of the x-angle, y-angle, and z-angle for the pair of projected marker regions selected in (3-4) above are entered into ImageJ's TransformJ Rotate Plug-in to execute the rotation operation (command below) (step S9). Specifically:

run (“TransformJ Rotate”, “z-angle=z-angle y-angle=y-angle x-angle=x-angle interpolation=Linear background=0.0 adjust resample anti-alias”);

For example, in FIG. 19, z-angle (average) is 39.1°, y-angle (M4) is 2.58°, and x-angle (M9) is 2.62°, so these values are entered.

(3-6)

If necessary, (x and y)-angles are searched around in the current orientation (step S10).

(3-7)

If the number of matches exceeds the evaluation criterion, the orientation adjustment is complete. If the number of matches is less than the evaluation criterion, return to the step described in (3-2) above (step S2) and add a marker region. (3-8) Evaluation of orientation adjustment by number of marker region matches

If, as a result of the orientation adjustment according to the above flowchart, a location marker for a particular marker region appears in the projected marker region in the fiducial slice, the X-ray and light microscope images for that marker region are considered to be matched. The evaluation criterion for the orientation adjustment is the number of matches of the marker regions, which is 6 to 8. In other words, the orientation adjustment is complete when there are 6, 7, or 8 or more, preferably 8 or more, marker region matches. In 3 specific cases where there were 8 or more marker region matches and orientation adjustment was successful, the residual average of the x-angles or y-angles of these matched marker regions was 0.21° to 0.34°. Therefore, the accuracy of the precise match obtained by this method can be considered to be roughly within 0.5°.

The light microscope image may contain a deformation resulting from sample preparation, which may cause a local structural difference between the X-ray and light microscope images. Therefore, the collation between the X-ray microscope image and the light microscope image may further comprise a step of correcting the image data of the light microscope image (using Fiji's Rigid Registration, etc.).

Software can be designed to automate the above flowchart.

### 6. Three-Dimensional Evaluation of Matched Image Data

In one aspect of the present invention, a method for extracting an evaluation target region of a biological sample in three dimensions based on both of matched X-ray microscope image and light microscope image, comprises the steps of:
extracting an observation target region (region of interest), including the evaluation target region, from the image of the X-ray microscope matched with the image of the light microscope; and
binarizing the region of interest to further extract the evaluation target region from the region of interest.

### (1) Extraction of Region of Interest Including Region to be Evaluated

A region of interest is extracted from an X-ray microscope image as an observation target region including a region to be evaluated, using image analysis software with a shape or region selecting function (ImageJ's Polygon Selection tool, etc.). Here, the accuracy of the extraction can be increased by confirming the extraction boundary by referring to a light microscope image with a clearly stained basement membrane, etc. by the method of the present invention shown in the example.

In the present invention, the shape of the extracted region of interest may be three-dimensional (3D) or planar (2D).

In the present invention, the region of interest including the evaluation target region is extracted using both images in a complementary manner, but the present invention is not limited thereto, and the region of interest including the evaluation target region may be extracted from the X-ray microscope image alone.

### (2) Extraction of Evaluation Target Region

The evaluation target region is binarized and extracted from the X-ray microscope image using image analysis software having a function of creating a binary image and a function of selecting a shape or a region (ImageJ's Threshold tool, Polygon Selection tool, etc.). Here, according to the method of the present invention shown in the example, the shape continuous in the depth direction is confirmed in the X-ray microscope image with isotropic spatial resolution and the number of cells contained in the evaluation target region or the like is confirmed by referring to the light microscope image with clearly stained cell nuclei. The accuracy of the extraction can be increased by this complementary use of light and X-ray microscopes.

### (3) Evaluation of Evaluation Target Region

The process for evaluating the volume or shape of the extracted evaluation target region is as follows.

The volume or three-dimensional shape of the evaluation target region extracted from the X-ray microscope image is evaluated by the method of the present invention shown in the example. The volume is calculated by multiplying the number of voxels in the region by the voxel volume, allowing quantitative evaluation of the volume, which is difficult with light microscopic observation. The three-dimensional shape is an evaluation index that cannot be obtained from the light microscope image when the evaluation target region has a complex three-dimensional structure or when the spatial relationship between the evaluation target region and other tissues needs to be known. Furthermore, if the evaluation target region is located between the sections of the light microscopic sample, the X-ray microscope image that is continuous in the depth direction is advantageous.

Software can be designed to automate the above three-dimensional evaluation using AI or the like. The software can be configured as a black box that performs the extraction of the evaluation target region and the three-dimensional evaluation as a series of operations, or it can be configured interactively so that it first proposes a list of a number of extracted evaluation target region candidates and then performs the three-dimensional evaluation on the candidates designated by the user.

### 7. Microscope Image Processing Device, Program, and Recording Medium

The present invention further provides a device for processing microscope images and a computer program for processing microscope images.

The device of the present invention is a microscope image processing device for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, the device comprising:
a means for extracting an observation target region (region of interest), including the evaluation target region, from the images of the biological sample, which are captured by the X-ray microscope and the light microscope and matched; and
a means for binarizing the extracted region of interest to further extract the evaluation target region from the region of interest.

The device of the present invention is used for analyzing a biological sample.

In addition, the program of the present invention is a program for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, wherein the program enables a computer to function as the following means:
a means for extracting an observation target region (region of interest), including the evaluation target region, from the images of the biological sample, which are captured by the X-ray microscope and the light microscope and matched; and
a means for binarizing the extracted region of interest to further extract the evaluation target region from the region of interest.

The program of the present invention is used for analyzing a biological sample.

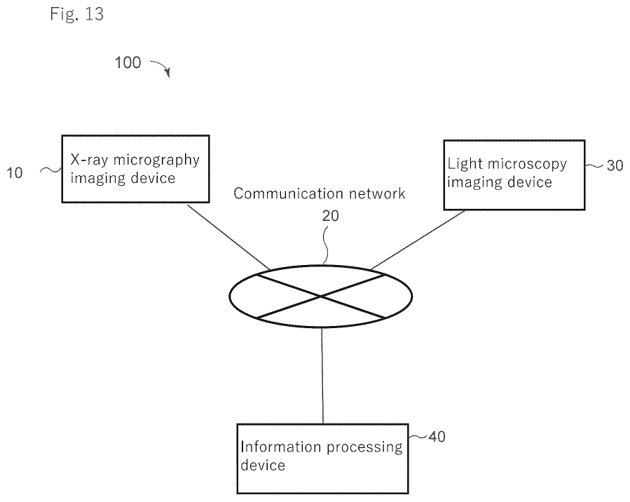

FIG. 13 shows an overview of a microscope image processing device 100 provided by the present invention. In FIG. 13, the microscope image processing device 100 is provided with an X-ray microscopy imaging device 10, a light microscopy imaging device 30, and an information processing device 40. These devices may be connected via a communication network 20 as shown in FIG. 13. Alternatively, the X-ray microscopy imaging device 10, the light microscopy imaging device 30, and the information processing device 40 can be installed independently without being connected to a network. In this case, only necessary information such as image data can be imported into and processed by an independent information processing device.

For example, in accordance with the DICOM (Digital Imaging and Communications in Medicine; DICOM) standard, the X-ray microscopy imaging device 10 writes basic information such as the information of patient from whom the sample is taken, examination information, and image ID into the header of the image file and transmits it to the information processing device 40. In the present invention, the X-ray microscopy imaging device 100 is preferably nano3DX (Rigaku Corporation).

The light microscopy imaging device 30 is a commonly used microscope such as a stereomicroscope, an inverted microscope, or a metallurgical microscope, but it may also be a digital microscope equipped with a high-resolution digital camera instead of ocular lens. By using a digital microscope, the captured microscope image can be saved as a digital image. In this case, information of the image captured by the light microscope is transmitted to the information processing device 40.

The information processing device 40 is a computer device that analyzes the image transmitted from the X-ray microscopy imaging device 10 and the image transmitted from the light microscopy imaging device 30 to assist in the examination of the biological sample and outputs this image information. Once an X-ray microscope image is acquired by irradiating a biological sample with X-rays and capturing its image, the information processing device 40 acquires location information of the biological sample for observation with the light microscope using an arbitrary location of the biological sample as a reference. Once the location information is acquired, the information processing device outputs the location information.

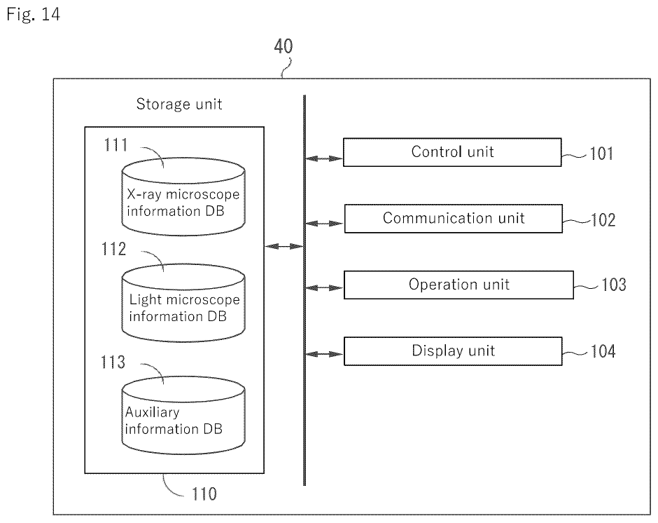

As shown in FIG. 14, the information processing device 40 is provided with a control unit 101, a communication unit 102, an operation unit 103, a display unit 104, and a storage unit 110.

The control unit 101 is configured with a CPU, a ROM, a RAM, etc., and comprehensively controls the processing operation of each unit of the information processing device 40. Specifically, the CPU reads various processing programs stored in the ROM, expands them in the RAM, and performs various processes in cooperation with the programs.

The information processing device 40 also has the storage unit 110 in the ROM or RAM, and the storage unit 110 includes an X-ray microscope information database (DB) 111, a light microscope information DB 112, and an auxiliary information DB 113. The auxiliary information DB stores the name of the human or animal tissue from which the biological sample is taken, ID, date of sample collection, datum plane, thickness of the section, fiducial region, and marker regions.

The control unit 101 performs the function of displaying images on a monitor or the like (not shown) in cooperation with the display unit 104 by executing the process of acquiring information of the image captured by the X-ray microscope and information of the image captured by the light microscope.

The communication unit 102 is configured with a network interface or the like, and transmits and receives data to and from the X-ray and light microscopy imaging devices connected via the communication network, as well as to and from external equipment connected to the information processing device.

The operation unit 103 is a keyboard equipped with various input and function keys, a mouse, etc., and operation signals input by key operations on the keyboard or mouse operations are output to the control unit 101. The operation unit 103 may also be configured with a touch panel, in which case operation signals are output to the control unit 101 in response to touch operation by the user.

The display unit 104 is configured with a monitor such as an LCD (liquid crystal display), etc., and displays various screens according to the instructions of the signal inputs from the control unit 101.

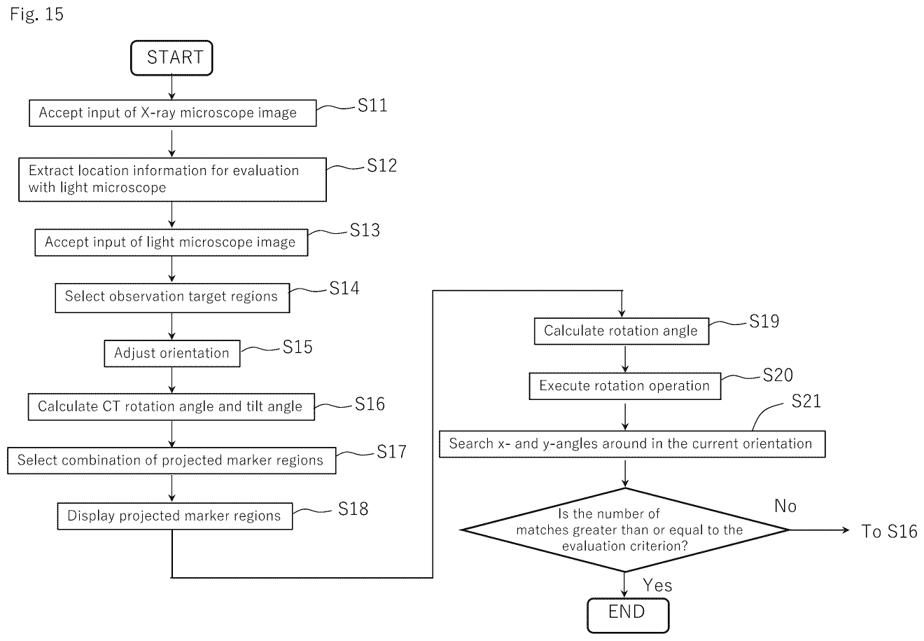

FIG. 15 is a flowchart showing the orientation adjustment process by the microscope image processing device of the present invention.

First, the control unit 101 of the information processing device 40 accepts input of an X-ray microscope image and sets it as a target image 1. The control unit 101 specifies, from the target image 1, observation target regions contained in the biological sample that can be used as location markers for orientation adjustment (first specifying means). The control unit 101 executes the image analysis process based on this target image (step S11). The image analysis process is executed by the cooperation of the control unit 101 with the program stored in the storage unit 110.

Next, the location information to be evaluated in detail with the light microscope is extracted from the target image 1 (step S12).

As shown in FIG. 11, the thickness of a single slice can be set as desired, and thus the control unit 101 can obtain the distance dₙ from the location (d₀) of the datum plane U (datum image) of the biological sample to the n-th image. The thickness of the slice can be entered by the user or can be preset.

Next, the control unit 101 accepts input of a light microscope image and sets it as a target image 2 (step S13).

The control unit 101 selects, in the target image 1 and the target image 2, observation target regions that can be used as location markers for orientation adjustment (step S14). Specifically, the control unit 101 specifies observation target regions corresponding to the observation target regions specified by the first specifying means, in an image, captured by the light microscope, of a part of the biological sample included in the image captured by the X-ray microscope (second specifying means).

The morphology of the observation target regions can be selected by allowing a morphology discriminator to learn the morphology in advance to automatically select a morphology that matches or resembles that morphology, or by accepting input of a morphology selected by the user. In step S14, for example, an image feature such as density, shape, texture, or multi-resolution feature is extracted in pixel units for each slice of the microscope image. One or more types of image features may be extracted.

The first and second specifying means specify the observation target regions based on an operation of designating observation target regions by the user, a priority predetermined for observation target regions, and/or a priority set in advance by the user. “Priority” refers to the order in which the observation target regions are specified, and indicates which observation target regions are specified in that order. For example, when selecting observation target regions as location markers for adjusting the orientation of an X-ray microscope image of a wax block-embedded renal biopsy sample, cell nuclei will be the first priority and a particulate defect morphology (fibrosis, etc.) will be the second priority.

The orientation error between the light microscope image and the X-ray microscope image is within 10°, but is not limited to this and may be 10° or more depending on the precision required.

Next, the control unit 101 executes the orientation adjustment process shown in FIG. 12B (step S15) to collate the information of the observation target regions specified by the first specifying means with the information of the observation target regions specified by the second specifying means.

According to the orientation adjustment process shown in FIG. 12B, the control unit 101 selects one fiducial region and a plurality of marker regions from the observation target regions containing the location markers.

During the operation of step S15, if the control unit 101 receives an input from the user to change the designation of the fiducial and marker regions, or if a marker region is added, it calculates the CT rotation angle θ₁ and the tilt angle θ₂ of the marker region in the XRM image and displays them on the display unit 104 (step S16).

The control unit 101 then calculates the projected marker regions, which are marker regions z-projected onto the fiducial slice, and selects specific regions from the plurality of projected marker regions. For example, if 3 projected marker regions (M1, M2 and M3) are selected as shown in FIG. 12A (c), two straight lines formed by one projected marker region-fiducial region-another projected marker region are extracted, and the angle formed by these lines is calculated to determine which combination of projected marker regions forms an angle closer to the right angle, and the candidate pair of projected marker regions is displayed (step S17).

Next, the control unit 101 displays the morphology of the projected marker regions (step S18). Then, the control unit 101 calculates the x-angle, y-angle, and z-angle as rotation angles for orientation adjustment (step S19).

The control unit 101 inputs the values of the x-angle, y-angle, and z-angle for the pair of projected marker regions into the storage unit 113 to perform a rotation operation, or displays the rotation angles on the display unit 104 for the user to perform a rotation operation (step S20). If, as a result of the orientation adjustment, a location marker for a particular marker region appears in the projected marker region in the fiducial slice, the X-ray and light microscope images are considered to be matched for that marker region. If necessary, (x and y)-angles are searched around in the current orientation (step S21). If the number of marker region matches exceeds the evaluation criterion, the orientation adjustment is complete. If the number of matches is less than the evaluation criterion, add a marker region and return to step S16. The evaluation criterion is set to 8 by default and can be changed as needed within the range of 6 to 8.

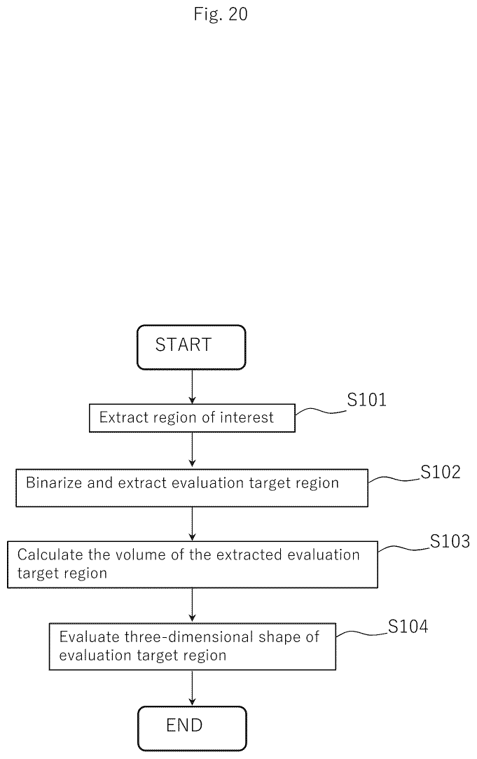

A flowchart of the processes up to the evaluation of the three-dimensional shape of an evaluation target region is shown in FIG. 20.

In FIG. 20, an observation target region (referred to as a “region of interest”), including a region to be evaluated, is extracted from the images whose orientations have been adjusted as described above (step S101).

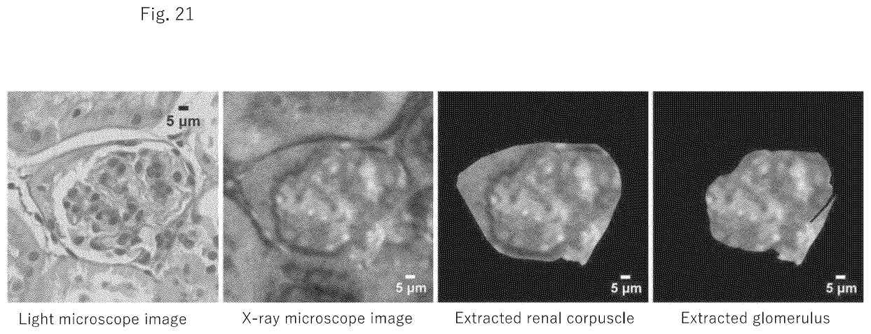

The region of interest is extracted using the size, structure or type of cell or tissue, cell nucleus, or defect morphology in the biological sample as a marker. The defect morphology includes cancer, fibrosis, calcification, lithiasis, deposits, and the like. For example, in FIG. 21, the renal corpuscle of a mouse kidney and its internal glomerulus are extracted as a region of interest. Here, the accuracy of the extraction can be increased by the complementary use of light and X-ray microscopes. “Complementary use” refers to a complementation in which the characteristics or advantages of either a light microscope or an X-ray microscope are complementary to those of the other microscope, which does not have such characteristics or advantages or has them to a lesser extent. For example, the continuous shape in the depth direction is confirmed in the X-ray microscope image with isotropic spatial resolution while the extraction boundary is confirmed by referring to the light microscope image with a clearly stained basement membrane, etc. The region of interest may be extracted using a computer-aided detection support system equipped with an image processing tool, etc., or it may be designated by the user using the operation unit 103 in the target image displayed on the display 104. In step S101, for example, an image feature such as density, shape, texture, etc. is extracted in pixel units for each slice of the X-ray microscope image.

In step S101, the control unit 101 corresponds the information of the extracted region in the light microscope image and the X-ray microscope image by referring to the light microscope image and displays it on the display unit 104. For example, as shown in FIGS. 21-23, the light microscope image and the X-ray microscope image are displayed side by side. Note that the light microscope image and the X-ray microscope image may be displayed side by side or superimposed.

Next, the control unit 101 performs feature analysis on the region of interest, and binarizes and extracts the evaluation target region for each slice of the X-ray microscope image to obtain its information. (Step S102). If evaluation target regions within a region of interest have the same pathological characteristics, they are extracted as homogeneous evaluation target regions, whereas if the region of interest contains regions with multiple pathological characteristics, they can be extracted as multiple heterogeneous evaluation target regions. Here, the accuracy of the extraction can be increased by the complementary use of the light and X-ray microscopes. For example, the continuous shape in the depth direction is confirmed in the X-ray microscope image with isotropic spatial resolution, while the number of cells contained in the evaluation target region or the like is confirmed by referring to the light microscope image with clearly stained cell nuclei.

Next, the control unit 101 calculates the volume of the evaluation target region contained within the region of interest based on the binarized information (step S103). The volume is calculated by multiplying the number of voxels in the image of the extracted evaluation target region by the voxel volume.

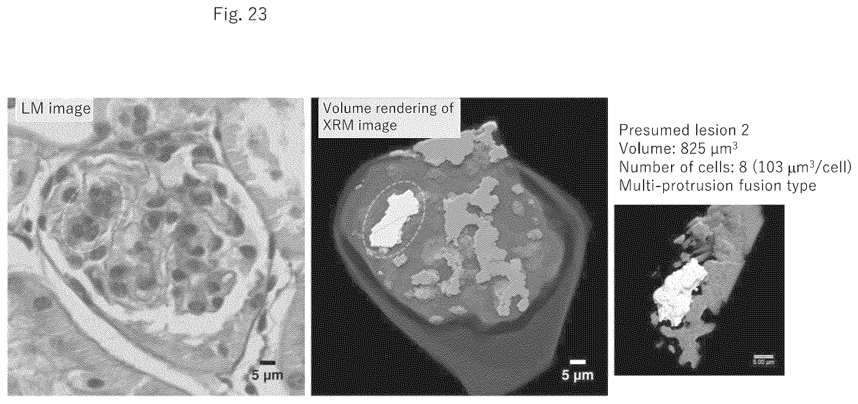

Next, the control unit 101 displays the three-dimensional shape of the evaluation target region on the display unit (step S104). The control unit 101 can display a morphology that matches or resembles a morphology pre-learned by a morphology discriminator, or can accept input of a morphology from the user. In these images, for example, an enclosing line (annotation) may be displayed around the evaluation target region (lesion), as shown in FIG. 23.

The program of the present invention can be stored on a computer-readable recording medium. Therefore, a computer-readable recording medium storing the program of the present invention is also included in the present invention. Examples of the recording medium or the storage means include, but are not limited to, a magnetic medium (flexible disk, hard disk, etc.), an optical medium (CD, DVD, etc.), a magneto-optical medium, and flash memory.

The functions of the elements disclosed herein may be implemented using circuitry or processing circuitry including general purpose processors, special purpose processors, integrated circuits, Application Specific Integrated Circuits (ASICs), Field Programmable Gate Arrays (FPGAs), conventional circuits, and/or combinations thereof that are programmed with one or more programs stored in one or more memories or otherwise configured to perform the disclosed functions. A processor is considered to be a processing circuitry or circuitry because it includes transistors and other circuits. A processor may be a programmed processor that executes a program stored in a memory. In this disclosure, a circuit, unit, or means is hardware that performs the recited functions or is hardware that is programmed to perform the recited functions. The hardware may be any hardware disclosed herein that is programmed or configured to perform the recited functions.

### EXAMPLES

Hereinafter, the present invention will be described further in detail by way of examples. The scope of the invention, however, should not be limited to these examples.

### Example 1

### Method

Whether it is possible to observe a same measurement point of a same biological sample with an X-ray microscope and a light microscope to evaluate the tissue in an observed region in three dimensions was experimented using a wax (paraffin)-contrasted mouse renal biopsy test sample. The experiment was performed using a kidney from a renal disease mouse model prepared according to the partial nephrectomy method described in the literature (Kunishima et al. (2022) Scientific Reports 12, 9436). Next, a wax-contrasted sample (wax block) was prepared from the kidney of the disease mouse model according to the method described in the above literature.

Then, an X-ray microscopic observation sample was prepared from the above wax block according to the direct mounting method described in the above literature. The sample was mounted on X-ray microscope nano3DX (Rigaku Corporation) (CCD detector) and X-ray projection image data were taken under the following conditions: Cu-target (40 kV/30 mA), L0270-bin1-XD2 (0.27 μm/voxel), Step scan (3,400 frames, exposure of 60 seconds per frame) (time required: 57.7 hours).

These projection image data were processed for ring artifact correction, drift correction, and phase retrieval (Paganin method; 8/B=100), followed by CT reconstruction by software based on the common FBP algorithm. The renal biopsy test sample after the X-ray microscopic observation was further re-embedded in a wax (paraffin) block, sequentially sectioned into 4 μm thick sections using a microtome, and stained with PAS reagent (periodic acid Schiff's reagent) to prepare samples for light microscopic observation, which were observed using Nano Zoomer C9600-03 (Hamamatsu Photonics K.K.), a light microscope for observation of sequential sections. Rough alignment of the X-ray and light microscope images was performed manually using common display software (ImageJ and Drishti). The orientation was then adjusted according to the orientation adjustment process described in the specification.

Using the precisely oriented X-ray and light microscope images obtained as described above, an attempt was made to evaluate the glomerular lesion in three dimensions using the method of the present invention. First, as shown in FIG. 21, a region of interest was extracted from the X-ray microscope image using ImageJ's Polygon Selection tool. In this example, the renal corpuscle and its internal glomerulus were extracted from a partial X-ray microscope image consisting of 400 CT slices containing one mouse renal corpuscle. Here, the extraction boundary was confirmed by referring to a light microscope image with a clearly stained basement membrane. The light microscope image may contain some deformation resulting from the sample preparation. If there is a local structural difference between the X-ray and light microscope images, the X-ray microscope image is considered to be closer to the actual structure.

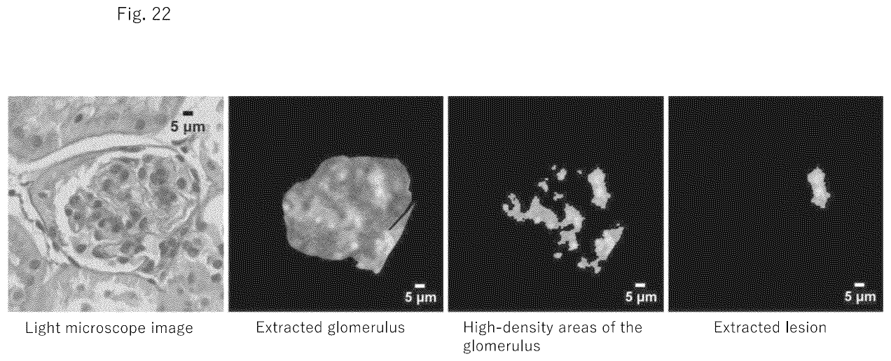

Next, as shown in FIG. 22, a lesion with clustered mesangial cells was binarized and extracted as an evaluation target region from the X-ray microscope image using ImageJ's Threshold tool and Polygon Selection tool programs. Here, the continuous shape in the depth direction was confirmed in the X-ray microscope image with isotropic spatial resolution, while a mass of clustered mesangial cells protruding from the normal mesangial cells, which are connected and extending like a chain, was selected as the lesion. The number of cells in the lesion or the like was confirmed by referring to the light microscope image in which the nuclei of the mesangial cells were clearly stained. The complementary use of the light and X-ray microscopes as described above can increase the accuracy of the extraction of the renal corpuscle, glomerulus, and lesion. Finally, the volume of the lesion was calculated by multiplying the number of voxels in the extracted lesion image by the voxel volume. In addition, the three-dimensional shape of the lesion was evaluated by displaying in three dimensions using the program Drishti.

### Results:

A three-dimensional view of the lesion created using the program Drishti is shown in FIG. 23. The volume of the lesion enclosed by the dashed line was calculated to be 825 μm³. The three-dimensional shape of a multi-protrusion fusion type lesion, in which multiple lesion protrusions arising from a single normal mesangial cell chain have fused and grown large, was visualized. The results of the above experiment showed that it is possible to practically evaluate a lesion in the tissue of a living body in three dimensions at the cellular level by the method of the present invention, which complementarily uses image information from light and X-ray microscopes.

### REFERENCE SIGNS LIST

10: X-ray microscopy imaging device, 20: Communication network, 30: Light microscopy imaging device, 40: Information processing device, 100: Microscope image processing device
101: Control unit, 102: Communication unit, 103: Operation unit, 104: Display unit, 110: Storage unit
701: Biological sample, 702: Block, 703: Cassette, 704: Stage, 705: Attachment member, 706: Cutout area of cassette
90: Position adjusting mechanism, 901: Support table, 902: Adjusting unit

What is claimed is:

1. A method for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, the method comprising the steps of:
extracting a region of interest, including the evaluation target region, from the image of the X-ray microscope that has been matched with the image of the light microscope; and
binarizing the region of interest to further extract the evaluation target region from the region of interest by using the image information of the light microscope and the X-ray microscope in a complementary manner.

2. A method for evaluating a biological sample, comprising a step of evaluating the volume or shape of the evaluation target region extracted by the method according to claim 1.

3. The method according to claim 2, wherein the volume is evaluated by multiplying the number of voxels in the image of the binarized evaluation target region by the voxel volume.

4. A method for displaying an evaluation target region of a biological sample, comprising a step of displaying the evaluation target region extracted or evaluated by the method according to claim 1 in a three-dimensional manner.

5. A microscope image processing device for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, the device comprising:
a means for extracting an observation target region (region of interest), including the evaluation target region, from the images of the biological sample, which are captured by the X-ray microscope and the light microscope and matched; and
a means for binarizing the extracted region of interest to further extract the evaluation target region from the region of interest.

6. The device according to claim 5, wherein the extraction of the region of interest and the extraction of the evaluation target region are performed by comparing the light microscope image with the X-ray microscope image using image analysis software having a function of creating a binary image and a function of selecting a shape or a region.

7. The device according to claim 5, further comprising a means for evaluating the volume or shape of the extracted evaluation target region.

8. The device according to claim 7, wherein the volume is evaluated by multiplying the number of voxels in the image of the binarized evaluation target region by the voxel volume.

9. The device according to any one of claim 5, further comprising a means for displaying the extracted or evaluated evaluation target region in a three-dimensional manner.

10. A computer-readable recording medium storing a program for extracting an evaluation target region of a biological sample in three dimensions based on two images that are matched: an image of the biological sample embedded in a wax block captured by an X-ray microscope using X-rays having an energy of 4-12 keV and an image of a same measurement point of the same biological sample captured by a light microscope after the X-ray microscopy imaging, wherein the program enables a computer to function as the following means:
a means for extracting an observation target region (region of interest), including the evaluation target region, from the images of the biological sample, which are captured by the X-ray microscope and the light microscope and matched; and
a means for binarizing the extracted region of interest to further extract the evaluation target region from the region of interest.
